(19) United States
(12) Patent Application Publication
(10) Pub. No.: US 2018/0005200 A1
(43) Pub. Date: Jan. 4, 2018

(54) GENERATION AND DELIVERY OF DIGITAL RECEIPTS BASED ON USER PREFERENCES AND TRANSACTION RELATED DATA

(71) Applicant: ecrebo Limited, Marlow-Buckinghamshire (GB)

(72) Inventors: Hassan Hajji, Marlow-Buckinghamshire (GB); Roman Valiusenko, Marlow-Buckinghamshire (GB)

(73) Assignee: ecrebo Limited, Marlow-Buckinghamshire (GB)

(21) Appl. No.: 15/541,780

(22) PCT Filed: Jan. 6, 2016
(86) PCT No.: PCT/GB2016/050022

§ 371 Date: Jul. 6, 2017

(30) Foreign Application Priority Data
Jan. 6, 2015 (GB) 1500095.3

(51) Int. Cl. G06Q 20/04; G06F 21/31; G06F 17/30

(52) U.S. Cl. CPC G06Q 20/0453; G06F 17/30864; G06F 21/31

(57) ABSTRACT

A method of delivering a digital receipt relating to a transaction to a user, the method comprising, at a server: receiving transaction related data from a point of sale system, the transaction related data having been intercepted in a data communications path between a point of sale terminal and a peripheral device; analysing transaction related data to extract user identification data; querying a user data module using extracted user identification data to determine user preferences relating to delivery of digital receipts; generating the digital receipt in dependence on the determined user preferences and the received transaction related data; outputting the digital receipt.

### FIELD OF THE INVENTION

The present invention relates to digital receipts. In particular, the present invention relates to a method of delivering a digital receipt to a user following a transaction at a point of sale system. The invention extends to a system for delivering a digital receipt.

### BACKGROUND TO THE INVENTION

Traditionally following a transaction at a retailer, the customer (user) would be issued a physical receipt detailing the various items that had been bought in the transaction. More recently, retailers have offered the chance to receive a digital representation of the physical receipt either by email or via an interface to an online service. Digital receipts have benefits for the customer in that they can be stored, organised electronically and retrieved more easily than physical receipts which often get lost or, if not stored properly, damaged. For the retailer digital receipts are beneficial because they are save printer paper (and associated hardware) and allow (provided there's a customer agreement) more targeted marketing.

One of the simplest methods of issuing digital receipts is to require a customer to input an email address at a point of sale (POS) system or to provide/spell their email addresses to a cashier. This method of issuing digital receipts is error-prone. Entering an email address, either by the customer at a POS user interface or by the cashier, is time consuming and subject to data entry errors all of which may negatively impact sales performance. Additionally, customers may not be comfortable spelling out their email address to a cashier as the email address may be considered sensitive information which can be overheard.

To mitigate these issues, a retailer may choose to change the existing software loaded at POS to use an association between an email address and a unique identifier associated with the customer, such as a payment card number (or its hash token) or a loyalty card number. In this case, the user isn't required to spell or input an email address at a point of sale system during every transaction, since the system can retrieve an email address using an association between user's identifier and email address stored in the database.

In a variation of the above method, customers may use an application to generate a user specific barcode and then present this barcode at the point of sale system for use as their unique identifier. However, this method requires customers to register with an additional service in advance of the transaction, print out a barcode and then carry the barcode along and present to the cashier every time they purchase something. It is noted that the barcode could be delivered to a mobile device but it is also noted that not all scanners are capable of scanning of images on LCD screens, and not many mobile devices use e-ink displays.

In any case, the above mentioned methods all suffer from the same disadvantages in that they require either a great deal of integration with a payment terminal at a POS system and/or they required point of sale hardware or software to be altered.

Instead of entering an email address at the POS system, other systems allow customers to retrieve digital receipts via on-line service. This method usually requires a transaction identifier to be provided to the customer, e.g. by being printed on a physical receipt. This in turn requires the customer to retain the transaction identifier or to hold the original physical receipt at hand. If the customer doesn't have the original receipt/transaction identifier for any reason, the customer is unable to retrieve its digital copy. If paid by credit card, the transaction data may potentially be partially restored using an online banking service, however, if the customer paid by cash, retrieval of the receipts becomes impossible in most cases.

U.S. Pat. No. 8,738,454 describes a method to associate a transaction with a mobile device. However the method requires additional hardware, an NFC device, to be added to the POS system. This in turn requires a customer to carry an NFC tag or an NFC enabled device.

### SUMMARY OF THE INVENTION

According to a first aspect of the present invention there is provided a method of delivering a digital receipt relating to a transaction to a user, the method comprising, at a server: receiving transaction related data from a point of sale system, the transaction related data having been intercepted in a data communications path between a point of sale terminal and a peripheral device; analysing the received transaction related data to extract user identification data; querying a user data module using extracted user identification data to determine user preferences relating to delivery of digital receipts; generating the digital receipt in dependence on the determined user preferences and the received transaction related data; outputting the digital receipt.

The present invention provides a method of delivering a digital receipt to a user involved in a transaction that avoids the need for the retailer to modify their point of sale hardware or software to be able to send digital receipts to the user. The present invention provides a server arranged to receive transaction related data (both transaction data such as items in the transaction and transaction meta-data such as transaction card details, loyalty card details etc.) that has been intercepted during the normal working processes on the point of sale system (the “client” side). The received transaction related data is analysed to extract data that that may be used to identify the user and this identification data is sent to a customer data module to determine the user's preferences for receiving digital receipts. A digital receipt is then generated and delivered to the user in accordance with the stated delivery preferences.

The present invention has advantages over other systems and methods in that data interception modules may be installed on the point of sale system in the data communications paths between various elements of the point of sale system (such as the scanner, magnetic card reader, pole display and printer). Consequently, transaction related data may be received without the need to modify proprietary software or hardware components on the client side system (the point of sale system). Furthermore, preferred features of the invention allow a user to retrieve a digital receipt even when they are not in possession of a transaction identifier through a series of challenge questions that the server may derive from the received transaction related data.

According to the first aspect of the invention a digital receipts system, the server, receives transaction related data from a point of sale system. It is noted that the digital receipts system may be in continuous communication with the point of sale system or may be intermittently in contact with the point of sale system. It is further noted that the digital receipts system may receive the transaction related data directly from the point of sale system or via a further data store, such as the transactions data repository described below. Upon receiving the transaction related data the method according to the first aspect of the invention comprises analysing the received data to extract user identification data. The user identification data may also be used to query a user data module to determine a user's preferences for the delivery of a digital receipt. Once the user's preferences have been determined then a digital receipt may be generated and output. It is noted that in the event of no preferences being available the digital receipts system may prepare a digital receipt according to a default setting.

Optionally, user preferences may be stored in the user data module. The user data module may comprise a data store or database that is accessible by the server device.

Optionally, user preferences may comprise a message delivery preference and outputting the digital receipt may comprise outputting the digital receipt to the user in accordance with the specified message delivery preference.

Optionally, the message delivery preferences comprise an electronic communications address. The message delivery preference may comprise a user email address or other convenient delivery destination or mechanism. For example, the digital receipt may be output to a third party database or data store that the user has access to. Alternatively, the digital receipt may be sent to a smart device software app or via SMS or MMS message.

The message delivery preference may comprise a third party application program interface (API).

Optionally, in the event that the customer data module does not contain a message delivery preference, generating the digital receipt may comprise storing the transaction related data in a data store and awaiting digital receipt delivery information from the user. In this manner the digital receipt may be generated and the user may provide their message delivery preference at a later time.

Optionally, in the event that the customer data module does not contain a message delivery preference, generating the digital receipt may comprise generating a digital receipt in accordance with a default format and then storing the generated receipt in a data store and awaiting digital receipt delivery information from the user. In such an arrangement the user preference may be set to the default format in lieu of a user specified preference.

Optionally, in the event that the user data module does not contain a message delivery preference for the user, a processor of the server may generate a message to request a message delivery preference from the user. Such a message may be sent back to the client side system, the point of sale system, during the transaction in order that the user can provide message delivery preferences during the transaction. Alternatively, transaction related data may only be intercepted at the end of a transaction as it is sent to a printer device. In such circumstances the message may be sent to the user after the transaction has completed (e.g. an SMS may be sent to the user requesting that they access a user area of the server device to provide message delivery preferences in the event that the system has details of the user's telephone number. Alternatively the user may access the digital receipts system after being provided with access details during the transaction).

Optionally, where a message is returned to the client side system during a transaction, this message may be inserted into the client side system via a data interception module that has been installed on the client side system (point of sale system). Optionally, upon receipt of a message delivery preference from the point of sale system, the server may generate the digital receipt and send it to the user. Optionally, the server may also send the received message delivery preference to the user data module for storing and use in subsequent transactions.

Optionally, in the event that the customer data module does not contain a message delivery preference for the user, a processor of the server is arranged to generate a unique retrieval code to be printed on a physical receipt printed by the point of sale system, the unique retrieval code providing a link to a stored digital receipt for later retrieval by user. Optionally, the server may be arranged to generate a modified print command for a printer peripheral device located at the point of sale system and to send the modified print command to a data interception module installed in a data communications path between the printer peripheral device and a point of sale terminal within the point of sale system.

Optionally, in the event that the customer data module does not contain a message delivery preference for the user, the method comprises providing a user interface to the user, generating a series of challenge questions to the user, searching available transaction related data in dependence on answers to the challenge questions received via the user interface and, in the event that a single transaction is identified, outputting digital receipt data to the user via the user interface and, in the event that a single transaction cannot be identified, generating further challenge questions for the user. This feature may be used by the user to retrieve lost or missing receipt history since if the user can answer all the challenge questions the digital receipts system will provide them with a digital receipt.

Optionally, in the event that a single transaction cannot be identified after generating challenge questions, outputting a notification message to the user confirming that the server cannot identify their transaction.

Optionally, the challenge questions comprise a request to confirm one or more of the following: a store location; a store identifier; a point of sale location within a store, time and/or date of a transaction; transaction amount; loyalty card data; transaction card data or any other data that is available on the printed receipt that may be used to confirm the identity of the user.

According to a second aspect of the present invention there is provided a server for delivering a digital receipt relating to a transaction to a user, the server comprising: an input arranged to receive transaction related data from a point of sale system, the transaction related data having been intercepted in a data communications path between a point of sale terminal and a peripheral device; a processor arranged to: analyse the received transaction related data to extract user identification data; query a user data module using extracted user identification data to determine user preferences relating to delivery of digital receipts; generate the digital receipt in dependence on the determined user preferences and the received transaction related data; and an output arranged to output the digital receipt.

The second aspect of the present invention may incorporate preferred features of the first aspect of the present invention.

The invention extends to a non-transitory computer readable storage medium comprising computer readable instructions for a computer processor to carry out the method of the above aspect of the invention.

According to a third aspect of the present invention there is provided a distributed system for providing a digital receipt relating to a transaction to a user, the system comprising: (a) a client side computer system arranged to process user transactions, the processing of such user transactions generating transaction related data, the client side computer system comprising a client side processor and a peripheral device; (b) a user data storage device for storing a plurality of user records, each user record providing one or message delivery preferences for a user; (c) a computer server in communication via a data communications network with the client side system and the user data storage device, the computer server comprising: (i) an input arranged to receive transaction related data from the client side system, the transaction related data having been intercepted in a data communications path between the client side processor and the peripheral device; (ii) a server side processor arranged to: analyse the received transaction related data to extract user identification data; query the user data storage device using extracted user identification data to determine user message delivery preferences relating to delivery of digital receipts; generate the digital receipt in dependence on the determined user preferences and the received transaction related data; (iii) an output arranged to output the digital receipt.

According to a fourth aspect of the present invention there is provided a computer server for providing a digital receipt relating to a transaction to a user, the server being in communication via a data communications network with a client side system for processing user transactions and generating transaction related data and a user data storage device, the server comprising; (a) an input arranged to receive transaction related data from the client side system, the transaction related data having been intercepted in a data communications path between a client side processor and a peripheral device of the client side system; (b) a server side processor arranged to: analyse the received transaction related data to extract user identification data; query the user data storage device using extracted user identification data to determine user message delivery preferences relating to delivery of digital receipts; generate the digital receipt in dependence on the determined user preferences and the received transaction related data; and (c) an output arranged to output the digital receipt.

The third and fourth aspects of the present invention provide a distributed system comprising a computer server, a user data storage device and a client side point of sale system. The invention according to the third and fourth aspects of the present invention is directed towards the automatic generation and transmission of a digital receipt corresponding to a physical receipt generated during the course of a transaction. The invention recognises that the advent of computer based transactions means it is challenging for user's to obtain transaction receipts in a convenient manner and format. The present invention proposes the interception of transaction related data during a transaction at a client device and then the subsequent analysis of the transaction related data to determine the identity of the user. Once the identity of the user has been determined then user preferences for the delivery of a digital transaction receipt may be determined by querying a user data storage device and then subsequently generating a digital transaction receipt in response to the user preferences and then transmitting the generated receipt to the user.

The user data storage device may contain data relating to a plurality of user records, each user record providing one or message delivery preferences for a user.

The third and fourth aspects of the present invention may incorporate preferred features of the first aspect of the present invention.

Further embodiments of the present invention may comprise:
The proposed invention relates to digital receipts, and presents a way of enhancement of POS to allow digital receipts, a method to retrieve a copy of the digital receipt by providing enough information about the transaction, as well as enables promotional programs. By means of a set of interception modules between the POS and hardware attached to the POS, and by using all the collected data from these modules, it is possible to enable digital receipt service and promotional program. This doesn't require integration with or change to the software loaded at POS.
A system for intercepting transaction data being sent from POS terminal to the printer or pole display, intercepting data being sent from magnetic card readers to the POS, intercepting data being sent from the optical scanners to the POS, and using this intercepted data (and, possibly, all historical data linked to this data) from all the devices to enhance POS functionality with digital receipt capabilities.
A method for retrieving digital receipt copy by providing enough information about the transaction details, normally without requiring to have a paper receipt copy.
In one embodiment, a transaction data is being sent to the printer. A data intercepting module intercepts data from the magnetic card reader and stores this data temporarily in memory. Another data intercepting module intercepts transaction data being sent to the printer and sends this data, along with the data intercepted from the magnetic card reader, to the transaction data store. A module within transaction data store analyses data intercepted from the magnetic card reader and queries to a separate facility to retrieve meta-data associated with it (such as customer's email address or customer's preferences). Then, the email sending module may or may not format transaction data for better user-readability prior to embedding this data into an email in the form of the digital receipt. Finally, the email with embedded transaction data is delivered the customer.
In case a customer has not received an email for any reason and does not have a paper receipt, she/he can still have a way to retrieve the receipt from the transaction data store. In one embodiment, the customer then needs to submit to the transaction data store interface the store address where transaction was done. The system may then may present a floor plan of the store. The customer then selects the till (can be approximate). Then, the system requires to input time and date when the purchase was done (can be approximate), finally the system requires to enter last four digits of the card that was used, its expiry date (if used on the paper receipt), and the card name. The system then searches for all transactions that match this data. If there are multiple choices, the system then optionally may ask for information about items that were bought during this transaction until there's only one receipt that match all this data. If the customer can answer all the questions correctly, the system considers that this is a legitimate purchaser, since the customer was able to answer all the questions, and therefore the system finally asks to enter an email address (or in another embodiment allow for other ways of delivering the digital receipt) and delivers the digital receipt.
An ability to uniquely identify the customer also allows to enable a loyalty program. Since the transaction data can be associated with the customer, it also means that promotional coupons/vouchers can be associated with the customer. Moreover, since the whole history of transactions associated with the customer is available to the system it also allows the system to do a more targeted coupon/voucher issuance, and allow for more sophisticated validation techniques at redemption.
Redemption of coupons/vouchers can be done automatically, since the redemption criteria can be checked by the system at the moment when a transaction is stored in the transaction data repository. For example, a coupon C is issued to the customer on transaction A. The coupon C gives 10% off the price of product X. This coupon is associated with the customer P. Next, the customer buys product X in transaction B. This transaction B is saved to the data repository. Redemption system detects that customer P has coupon C, and that transaction B has eligible products in the basket (i.e. X) that allows coupon C to be redeemed. Depending on customer P preferences, the coupon can be redeemed automatically, or the system may ask for a confirmation via some user interface (e.g. a mobile application). If confirmed by the customer or auto-redeemed, the customer P then gets amount of money saved (i.e. 10%) of product X to his/her account. This account can be some points account associated with the customer P, in which case money saved is translated into some equivalent amount of points, or it can be a real bank account where money saved using the promotion is being transferred. The bank account information can be input by the customer or be derived from the customer's payment card number or its hashtoken if such a mapping is possible.

Still further embodiments of the present invention are described in the following numbered clauses:
1. A system and computer product for capturing transaction data and its meta-data and sending of digital receipts to customers comprising:
   Data stream interceptors;
   Controller;
   Digital Receipt Sender;
   Transaction Data repository;
   Customer Data data store;
   User Interface;
   POS system with magnetic card reader, printer, scanner, payment terminal and other hardware.
   Matcher
   Redeemer
   Promotions Data Store
2. The system of Clause 1, where interceptors are intercepting data between POS and hardware devices such as printer, magnetic card reader, scanner, payment terminal, pole display etc. and optionally inserting data back into the POS system for receipt by, for example, the POS terminal, the printer device (if the returned data is inserted into the printer data stream from the POS terminal to the printer device) or other devices within the POS system (where returned data may be inserted into data streams entering or leaving such devices).
3. The system of Clause 1, where Controller is a module that controls interceptors, analyses intercepted data, and communicates to Transaction Data repository, and/or Customer Data data store, and/or Digital Receipt Sender or other components of the system.
4. The system of Clause 1 and Clause 3, where Controller enhances POS existing software with dialogs and interactions (e.g. asking to enter email address).
5. The system of Clause 1, where Transaction Data repository (i.e. a database, local or remote)is a facility that stores digital representations of transaction data (Transaction Data) and Transaction Meta-data and allows to query transactions data and meta-data from it using any set of transaction elements or meta-data elements or their values or value ranges etc. (i.e. as conventional database).
6. The system of Clause 1, where Customer Data data store (i.e. a database, local or remote)is a facility that stores all information and preferences of the customers that can be identified using unique customer identifiers such as loyalty card number or its hashtoken or data read by magnetic card device or its hashtoken, or payment card information or its hashtoken, or any other unique identifier or some combinations of these.
7. The system of Clause 1, where Digital Receipt Sender is a module that (see FIG. 4):
   Retrieves transaction data and its meta-data from Transaction Data Repository
   Identifies the customer by using transaction data and meta-data and gets digital receipt delivery preference settings and destinations (e.g. emails) from Customer Data data store for the given customer;
   Formats transaction data for the destination (e.g. email) and delivers the copy of the receipt to the destination address (e.g. email, dedicated account, mobile application, API, third party API, or any other sensible and practical destination);
8. The system of Clause 1 and Clause 4, where Digital Receipt Sender can also receive a destination address (e.g. email address) from Controller and deliver a digital receipt to the given destination;
9. The system of Clause 1 and Clause 4, where Controller can also update an entry in Customer Data datastore for the given customer with a new destination (e.g. email address that was submitted via dialog at POS or in some other way).
10. The system of Clause 1, where User Interface is a component that allows customer to interact with Customer Data datastore and updates records related to customers (e.g. a customer may login to update their email addresses or digital receipt delivery options etc).
11. The system of Clause 1, where Promotion Data Store is the storage that stores promotion related data such as promotion contents and terms, redemption and issuance criteria (e.g. total spend, location, items, payment information and/or any other information available in transaction data and meta-data), or any other promotion related information.
12. The system of Clause 1, where Matcher is a component that gets as input customer's data and customer's transaction data and/or meta-data and decides, taking into account promotions issuance criteria, which promotions can be issued to the customer. It also makes sure, depending on settings of the promotions, that promotions are not issued multiple times to the customer or are issued no more times than a pre-defined limit. The matched promotion can be delivered to different destinations, depending on promotion settings, which includes but not limited to:
   As email contents and/or attachment.
   As an offer to a mobile application.
   As a coupon printed at till.
   Delivered via third party API for further processing.
   Or any other sensible way of delivering coupons/vouchers.
13. The system of Clause 1, where Redeemer is a component, that gets as input customer's data, customer's transaction data and meta-data, and promotions issued to this customer, and identifies which promotions can be redeemed on which transaction, by inspecting promotion's redemption criteria. The redemption then needs to be confirmed by the customer explicitly or it can be done automatically depending on the customer's preferences.
14. The system of Clause 13, where redemption of a promotion transfers a reward to the customer as points, stamps, money or any combination of these, and makes the redeemed instance of a promotion no longer redeemable.
15. A method and computer product for retrieving transaction data without having original paper receipt comprising of asking detailing information about the receipt such as (see FIG. 5):
   Store location and/or identifier;
   Till location and/or identifier;
   Time and date when the transaction was done;
   Sum paid;
   Information about payment cards such as expiry, masked PAN, card name or anything else that was available on the original receipt;
   Information about loyalty card,
and querying Transaction Data repository, and checking the number of matching transactions, and depending on the number of transactions, allowing to retrieve the transaction data;
16. The method of Clause 11, where querying Transaction Data repository for all the transactions that match information given above exactly;
17. The method of Clause 11, where querying Transaction Data repository for all the transactions that match information given above, but the search is allowed to be done approximately in the sense that the sum, till location, and transaction time and date, can be given within some intervals. [It is noted that any data that appears on the transaction receipt may be used to query the transaction data repository. Additionally the method may allow ranges of values to be specified by the user so that they do not need to provide exact values]
18. The method of Clause 11, 12 and 13, where if there's only one transaction found that matches the given data, consider that the user knows enough about the transaction and allow to retrieve the full transaction data. If there are multiple transactions that match the given data, continue asking for information about the items bought such as (one, all or combination of the given below):
   Item description;
   Item bar code or some other identifier;
   Quantity bought,
until there's only one transaction that matches the given data; If no detailing information can be given at this step, consider that the transaction cannot be retrieved.

### BRIEF DESCRIPTION OF THE DRAWINGS

One or more embodiments of the invention will now be described, by way of example only, with reference to the accompanying drawings, in which:

FIG. 1 shows a typical configuration for a point of sale (POS) system;

FIG. 2 shows an OPOS architecture;

FIG. 3 shows an OPOS architecture in accordance with an embodiment of the present invention;

FIG. 4 shows a POS system in which intercepting modules have been installed to intercept transaction data;

FIG. 5 shows the interception of transaction related data from the POS system of FIG. 4;

FIG. 6a shows a digital receipts system in accordance with an embodiment of the present invention;

FIG. 6b shows the process of sending a digital receipt in accordance with an embodiment of the present invention;

FIG. 7 shows a method of retrieving a transaction in accordance with an embodiment of the present invention;

FIG. 8 shows a loyalty system in accordance with embodiments of the present invention.

### DETAILED DESCRIPTION

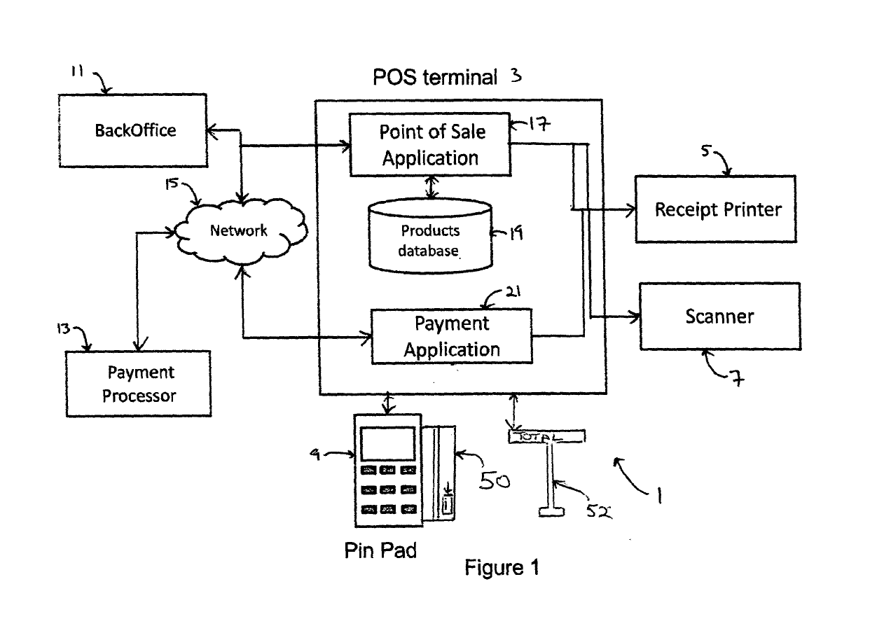

In the following description the following terminology is used
POS terminal is a computing device that is arranged to run and process transactions at a retailer. A POS terminal is usually in communication with one or more devices selected from: a Printer, Scanner, Magnetic Card Reader, Pole Display, Payment Terminal or other devices. The POS terminal and the one or more devices are collectively referred to as a “POS system”;
Printer—an output peripheral device capable of displaying or printing receipts, coupons, vouchers or other information. The Printer is in communication with the POS terminal;
Scanner—a scanner is an input peripheral device that is used to scan various kinds of barcodes such as 1D or/and 2D barcodes (e.g. QR-Code). The Scanner is in communication with the POS terminal;
Magnetic Card Reader—a peripheral device that is used to read magnetic stripe data from payment cards, loyalty cards or any other customer identifying media. The magnetic card reader is in communication with the POS terminal;
Pole Display—a peripheral device that is used within a POS system to display various information to the customer and/or the cashier. The pole display is in communication with the POS terminal;
Payment Terminal—is a peripheral device that is used for processing payment card transactions such as “Chip and PIN” devices. The “Chip and PIN” functionality allows payment card data to be read from a chip embedded in a payment device. It is noted that the magnetic card reader and payment terminal may be combined into a single physical device within a POS system. The Payment terminal is referred to below as the payment application module and is integrated with the POS terminal in FIG. 1;
Transaction Data—data that is printed on a receipt (either physical receipt or digital receipt);
Transaction Meta-data—data that is or may be associated with transaction data, such as scanned barcodes, or data read from magnetic card reader during a transaction, or generally any available meta-data for the given transaction data.
Transaction related data comprises transaction data and transaction meta-data;
Transactions Data Repository—a data store that stores digital representation of transaction data and transaction meta-data. The transaction data repository is in communication with the POS system and also the digital receipts system that generates and delivers digital receipts;
Customer Data store—a data store that stores all available information about a customer. It links customer preferences and all customer data and transaction history with unique customer identifiers (such as loyalty card numbers or hashtokens, payment card number or hashtokens, or, generally, with any unique customer identifier). The customer data store (also referred to herein as a customer data module) is in communication with the digital receipts system. In some embodiments the customer data module may be incorporated within the digital receipts system.

Turning to FIG. 1, a typical configuration of a POS system is shown. The POS system 1 comprises a POS terminal 3, printer 5, scanner 7, magnetic card reader 9, payment terminal 11 and pole display 13. It is noted that arrows denote typical data flow within the POS system (e.g. data goes from the POS terminal 3 to the printer 5).

Turning to FIG. 1, a typical configuration for a point-of sale (POS) system 1 is shown. The POS system comprises a POS terminal 3, a receipt printer 5, a barcode scanner 7, a data entry device 9 for the entry of PIN codes (the “Pin Pad”), back-office servers 11 and a payment processing server 13. The POS terminal, back-office servers 11 and payment processing server 13 are in communication with one another via a network 15 (which may be a local network, the Internet or a mixture of both).

The POS terminal 3 comprises a point of sale application software module 17, which is in communication with a product database 19, and a payment application software module 21. The POS system further comprises a magnetic card reader 50 and a pole display 52.

The point of sale application software module 17 and payment application software module 21 are each in communication with the receipt printer 5, scanner 7, magnetic card reader 50, pole display and with the back-office servers 11 and payment processing server 13 via the network 15.

The point of sale application software module 17 is responsible for recording items to be sold one by one, calculating the total balance, triggering any pre-configured promotions, and then accepting multiple payment methods. Typically, items are input in using the scanner 7. Items having barcodes printed on external packaging will be placed in front of the scanner 7 which then scans the barcode and passes the barcode as input to the POS software module 17. The POS software module 17 will then query the local database 19 to retrieve the price of the item which may be displayed on the pole display 52.

Once all items are scanned, the cashier asks the customer to confirm their preferred payment type to use, and if the user chooses to pay by card, the POS software module 17 connects to the payment application software module 21.

The payment application software module 21 drives external devices 9/52 to get the credit card details and optionally the PIN associated with the card. In cases where a PIN code is not required, the payment application software module may interface with a magnetic strip reader (which may be integrated with the device 9) which reads the card details when the user or cashier swipes the card through the strip reader.

Once the transaction is paid for, the POS application software module 17 formats details of the transaction and sends them to the receipt printer 5. In many cases, two or more receipts are printed: one for the customer, and one of the retailer. It is noted that the retailer copy of the receipt can potentially contain more information than the customer one (for e.g. full card details, while the customer receipt contains only the last 4 digits of the card used).

The payment application software module 21 is responsible for authenticating the card, verifying the PIN, and authorising the card for payment. This is done by accessing the payment processor 13 over the network connection 15. The payment processor 13 may be either hosted inside or outside the premises of the retailer, and in the case it is hosted outside the retailer's premises, the network path from the payment application software module 21 to the payment processor 13 may involve leaving the retailer's local computer network and using the Internet or other communications network (e.g. dedicated communications network or a mobile telecommunications network). The network 15 is also used by the POS application software module 17 to send transaction details to the back-office servers 11.

The POS application software module 17 typically runs on a commodity operating system (e.g. Microsoft Windows or Linux). Each of the devices external to the POS terminal 3 is connected to the machine using standard connectors: Serial, Parallel, USB, or Ethernet ports. To simplify the interoperability between POS software and payment software vendors and external devices vendors, a consortium of companies led by Microsoft, NCR, Epson, and Fujitsu-ICL standardised the interface between each device. These standards are typically implemented in Java or COM technologies, and known under the name of JAVAPOS or OPOS.

It is noted that OPOS is an implementation of an interoperability standard for a Windows® operating system using Component Object Model (COM) technology. OPOS defines a set of control objects that define the interface of each device, and a set of service objects that implement the interface above, in a set of libraries called service objects. Typically, the service object is provided by the hardware provider (e.g. Epson for the printers).

JAVAPOS is the implementation of the standard in JAVA language. It uses the same architecture as OPOS, with a set of JAVA classes defining the interface of the API, and another set of JAVA classes defining the implementation of these interfaces, called service objects. Typically, the manufactures provides the implementation for these service objects in JAVA.

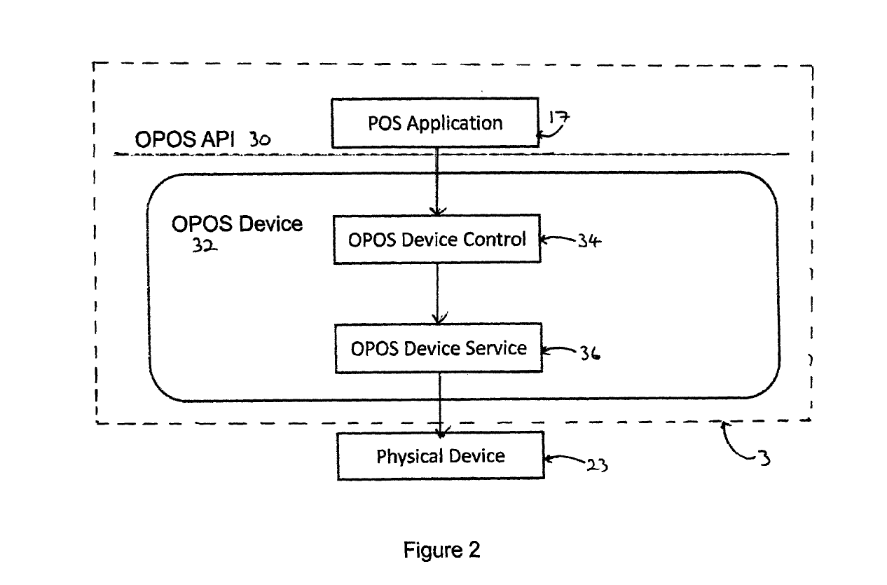

FIG. 2 shows a typical layout of the component of OPOS used to interface between a physical device 23 (e.g. the printer 5 or scanner 7 of FIG. 1) and the POS application software module 17. The POS application software module 17 is arranged to access the physical device 23 using a standard OPOS application programming interface (API) 30. Communication between the POS application software module 17 and the physical hardware device 23 is handled by an OPOS device 32 (which is actually a software stack within the POS terminal 3).

The OPOS device comprises an OPOS device control module 34 which provides the interface for the POS application software module 17 and an OPOS device service module 36 which provides communication to the device 23.

The OPOS Device Service module 36 implements the details of the physical device 23 and is typically provided by the hardware vendor. For example, to print receipt data, the POS application software module 17 may call the following method:
PrintNormal(Integer Station, String DataToBePrinted): Prints the data specified in “DataToBePrinted” to the station specified in parameter “Station”. This is guaranteed to work regardless of the underlying printer attached to the POS terminal 3.

Similar APIs exist for the scanner 7 as well. For example, regardless of the scanner attached to the POS terminal 3, the scanner property called “ScanData” always holds the scanned data. The POS application software module 17 upon receiving a read event from the scanner, can read this data, and it is guaranteed to hold the barcode of the item scanned.

An arrangement mirroring that of FIG. 2 may also be used to describe a JAVAPOS system for interfacing a POS software module with a hardware device.

To access the stream of data sent by the POS application software module 17 requires a change in the application so that appropriate code can be added in order to access the data.

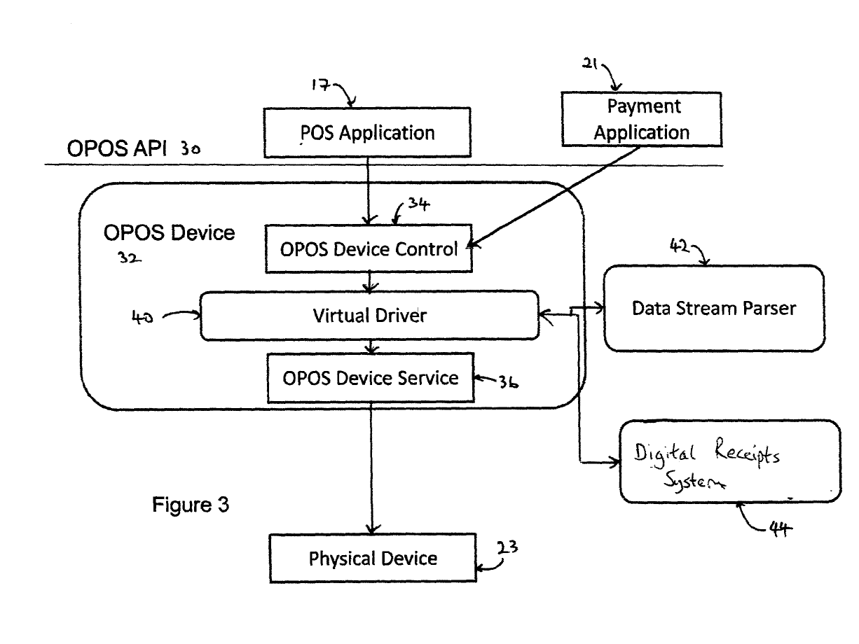

FIG. 3 shows an OPOS architecture for use in a POS system that is suitable for use with embodiments of the present invention. It is noted that like numerals are used to denote like features throughout the description.

The architecture depicted in FIG. 3 is similar to the known OPOS architecture of FIG. 2. The OPOS device 32 however now additionally comprises a virtual physical driver software module 40 that is located between the OPOS device control module 34 and the OPOS device service module 36.

The inclusion of the driver software module 40 enables data communications to and from the POS application software module 17 or payment application software module 21 to the physical device 23 to be monitored and intercepted. The driver software module 40 also enables data communications that originate from outside the POS system 1 to be inserted into the OPOS device 32 and routed to either the physical device 23 or the POS application 17/payment application 21 software modules. In this manner information relating to transactions can be extracted from the POS system 1 and additional information can be added into the communication path between the POS terminal 3 and physical devices (5, 7).

In more detail the virtual driver software module 40 may be installed and operated as follows:

In an installation step the virtual physical driver software module 40 may be installed onto the POS terminal 3 such that it sits between the OPOS device control software module 34 and the OPOS device service software module 36.

In a first operational step, each command passed through from either the POS application software module 17 or the payment application software module 21 to the physical device 23 may be monitored and passed to a data stream parser module 42.

In a second operational step, the data stream parser module 42 may parse the data to create a list of transaction items; total amount spent; details of any promotions; cashier name or id; and/or any other data of interest. The data stream parser 42 may be achieved using a regular expression parser. The stream parser 42 may also parse the details of the cards used (either partial details, such as last 4 card digits and expiry date, or complete details if available). It is noted that since the payment application software module 21 uses the stack OPOS device 32, the virtual physical driver module 40 may also intercept any extra information used when printing the retailer receipt (in case the retailer receipt contains full card details).

In a third operational step the virtual physical driver module 40 may pass the card and transaction data derived in the second step above to a computing device 44. The computing device 44 may comprise a module associated with the POS system 1, a separate local computing device or a remotely located device.

In a fourth operational step the computing device 44 may return modified data to the virtual physical driver module 40 which can then be supplied via the OPOS device service software module 36 to the physical device 23. In the example where the physical device 23 is the receipt printer 5 this allows the modified data (or a part or representation thereof) to be printed onto the customer's receipt.

In one example the computing device 44 may be a digital receipts system in accordance with the embodiments described below. It is noted that the driver module 40 may output transaction related data either directly to the digital receipts system or via an intermediate system such as a data repository.

The computing device may also incorporate an offer engine or loyalty system and depending on rules pre-set within the offer engine (e.g. to serve an offer to any customer who spent more than £20), the offer engine may generate an offer and pass it to the virtual physical driver module 40 for printing. Once the standard receipt data (e.g. store details, transaction items, transaction details etc.) has been printed, the virtual physical driver module 40 may print the offer received above to the POS system's receipt printer 5.

The virtual physical driver module 40 described above allows existing POS hardware to be used without any alterations to achieve the following:
Intercept transaction details without needing to modify the POS application software module 17;
Provide information from a computing device 44 to a customer using existing hardware (i.e. the receipt printer 5);
Associate transaction details with card details to thereby enable a loyalty scheme to be operated without any sign-up or loyalty cards to be used.

It is also noted that a POS terminal software module (either POS application software module 17 or Payment application software module 21) may in certain circumstances communicate directly with a physical hardware device rather than using an OPOS or JAVAPOS interface. Two alternative arrangements are therefore envisaged: (i) the software module (17, 21) may use ESC/POS (a command language used to drive receipt printers) or a similar language to directly to write to a serial port on the hardware device or to a USB device, or (ii) the software module may use a high-level printing API (for e.g. Windows printing architecture) and send rasterised data to the connected hardware device.

In arrangement (i) above, the data sent to the printer is a digital copy of the receipt and can be parsed as text. In arrangement (ii) above, the data sent to the printer is binary, and a parsing program would not be able to readily recover the details of the transactions.

In arrangement (i), the virtual driver software module 40 may be implemented as a filter driver.

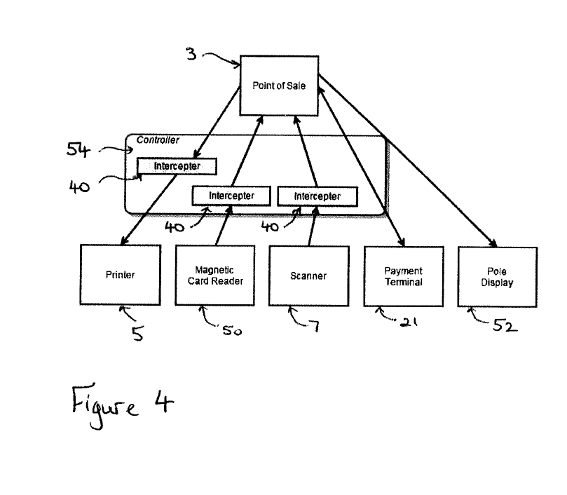

Turning to FIG. 4 a representation of the functional elements of a POS system suitable for use with embodiments of the present invention is shown.

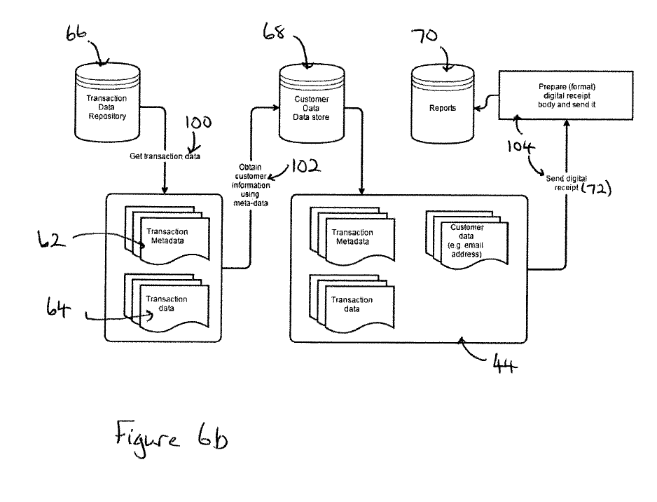

The POS system of FIG. 4 has a number of interception modules 40 installed within the POS system 1. As described above these interception modules 40 may be installed within the POS system 1 without needing to modify the POS terminal 3 software or to modify any hardware elements. The interception modules 40 enable data flowing in communication paths between the POS terminal 3 and the various devices (5, 7 21, 50 and 52) to be intercepted and sent to the digital receipts system 44 (described in relation to FIGS. 6a and 6b below).

As shown in FIG. 4 a plurality of interception modules 40 have been installed in each communication path between each peripheral device and the POS terminal 3. This plurality of interception modules is shown to be located within a controller module 54. In alternative arrangements a POS system 1 may comprise a single interception module 40 that taps into each exchange of data between each of the peripheral devices and the POS terminal 3.

The flow and collection of transaction related data 60 within a POS system 1 according to an embodiment of the present invention is shown in FIG. 3 and described below in relation to a customer transaction in a shop.

In one embodiment a customer visits a retailer and at some point during a transaction presents a loyalty card to the cashier at the POS system 1 within the retailer. The cashier may swipe the card using Magnetic Card Reader 50 and the interception module 40 between the POS terminal 3 and the Magnetic Card Reader 50 intercepts this data and stores it as part of transaction meta-data 62. During the transaction, the cashier may scan or input manually the products the customer bought.

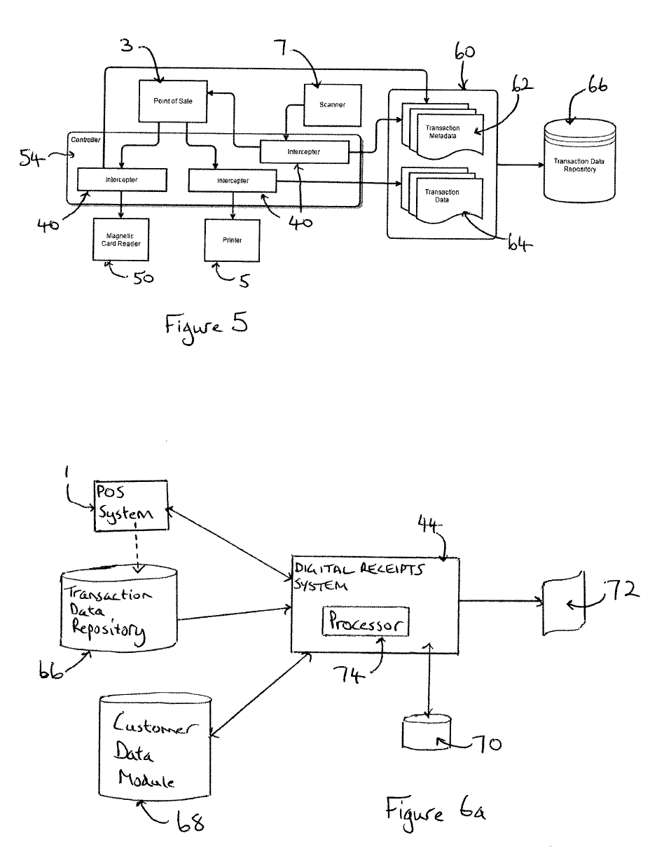

At this point the interception module 40 between the POS terminal 3 and the Scanner 7 may collect all the scanned barcodes as part of transaction meta-data 62 as well. At the end of the transaction, the customer pays for the items and a receipt is sent to the Printer 5 for printing. The interception module 40 between the Printer 5 and the POS terminal 3 intercepts this transaction data 64. The transaction data 64 and transaction meta-data 62 (e.g. scanned barcodes and data intercepted from the magnetic card reader 50) is then sent to a Transaction Data Repository 66. It is noted that in the embodiment shown in FIG. 5 the transaction related data is effectively the product of the interception modules 40 between the devices 5, 7 and 50.

It is noted that the transaction data repository 66 may form part of the retailer's systems. Alternatively, the repository 66 may be located remotely from the retailer's systems. In a further arrangement, the transaction data repository 66 may form part of the digital receipts system 44 described below.

FIG. 6a shows a digital receipts system 44 in accordance with embodiments of the present invention.

The digital receipts system 44, in the form of a server, is in communication with both the transaction data repository 66 and the POS system 1. The digital receipts system 44 is also in communication with a user (customer) data module 68. It is noted that the customer data module 68 may be a local system to the digital receipts system 44 or may alternatively be located remotely from the digital receipts system 44. The digital receipts system further comprises a data store 70 for storing data during the creation of a digital receipt 72 and a processor module 74 which is arranged to analyse received transaction related data to extract user identification data and to query the customer data module 68 to determine a user's preferences for the delivery of digital receipts (In a further embodiment the processor module 74 may extract user identification data with the assistance of the customer data module 68, e.g. if only partial transaction data is available via the intercepted transaction related data then the processor module 74 may be able to resolve the user's identity using data contained in the customer data module 68). The processor module is further arranged to generate a digital receipt in dependence on the determined user preferences. The digital receipts system 44 is arranged to output a digital receipt 72 either directly to a customer (user) or to the data store 70 for later collection by the user. Digital receipts 72 that are output directly to the user may be sent by email, SMS, via a dedicated smartdevice software app or any other convenient delivery path. Digital receipts 72 that are sent to the data store 70 may be access by the user logging into a user account area of the digital receipts system 44 or via a third party system that interfaces with the digital receipts system 44 via a suitable application program interface (API).

The user preferences for the delivery of digital receipts may comprise a communications address (e.g. an email address, mobile number). In the event that the user involved in the transaction has not configured their preferences then the digital receipts system 44 may revert to a default delivery option, e.g. store the digital receipt in the data store 70 for later retrieval by the user.

The processor module 74 may also manage the receipt recovery method described below and may be arranged to extract data from the digital receipt and to generate challenge questions for a user based on the extracted data such that a user can claim a digital receipt.

FIG. 6b shows the process of sending a digital receipt in accordance with an embodiment of the present invention and shows the data flow within the digital receipts system 44 as a digital receipt 72 is created.

The transaction data repository 66 stores transaction related data including transaction data and transaction meta-data (such as loyalty card data).

The processor module 74 is arranged to call for data from the data repository 66 (step 100). The repository 66 returns transaction related data comprising transaction data 64 and transaction meta-data 62 to the digital receipts system 44. The processor module is arranged to analyse the received data to extract data that may be used to identify the user. In this case the user identification data comprises loyalty card data intercepted from the Magnetic Card Reader 50.

The processor module 74 is then arranged to query (in step 102) the customer data module 68 using the extracted user identification data, to fetch customer preferences from the Customer Data module 68.

In one embodiment this preference data may include an email address which can be used to deliver a digital receipt 72 to the user. The processor module 74 is arranged to format the email and send it (step 104) to the user using the transaction related data returned from the transaction data repository 66. In this manner the processor module 74 may effectively generate a digital copy of the physical receipt and deliver this to the user (customer) by email. The processor module may be also generate a delivery report and store this in the data store 70 for analytics.

If the customer preferences stored in the customer data module 68 do not include the customer's email address at the point the transaction is occurring, then this may be indicated to the cashier via a suitable user interface (e.g. a display screen on the POS terminal 3). The cashier may then be prompted to ask the customer to input an email address at the POS system 1. In this scenario the digital receipts system 44 (and the processor module 74) may be arranged to generate a notification message to the cashier and to insert this into a data communications path leading to the POS terminal 3 via an interception module 40 (e.g. an interception module 40 between the payment application module 21 and the POS terminal 3 may be used to insert the notification message to the cashier). The response entered by the cashier may be intercepted by an interception module 40 and relayed to the digital receipts system 44 to take appropriate action (e.g. to write a received email address to the customer data module 68).

Alternatively, the customer may be given the option of submitting their contact details (email address or mobile number) at a later time via an online interface in order to create an association between the given email address and loyalty card data).

Where the customer data module 68 does not contain the customer's email address (or other contact details) for delivery of a digital receipt, the customer may indicate that the a digital copy of receipt is required, even if the customer doesn't wish to input email address at the POS system 1.

Such a request may be intercepted by an interception module and relayed to the digital receipts system 44. In response the digital receipts system 44 (via the action of the processor module 74 may generate a “proof of purchase” identifier that uniquely identifies the transaction and associates it with the customer. This identifier may be inserted into the data communications path between the POS terminal 3 and the printer 5 (via an interception module 40) such that the customer can use this unique number to request a digital copy of the receipt at a later time.

The unique transaction identifier and transaction related data may be stored by the digital receipts system 44 in the data store 70 until the customer accesses the system (e.g. via an online user interface). Since the transaction related data is already associated with the customer via the received loyalty card data, as soon as an email address of the customer becomes available in the customer preferences (which are in turn associated with loyalty card), the system will be able to deliver the digital receipt.

It should be understood that instead of loyalty card data intercepted from the Magnetic Card Reader 50 other ways of identifying the customer can be used. For example, loyalty cards often have barcodes printed on them, therefore the loyalty card number can be obtained by intercepting data from the Scanner 7. Since the loyalty card number encoded in the barcode is unique, it uniquely identifies the customer. Further, the customer may be identified by a transaction card number (or a subset or hash of the number). [The transaction card number may comprise the 16 digit payment card number of the front of a bank card]

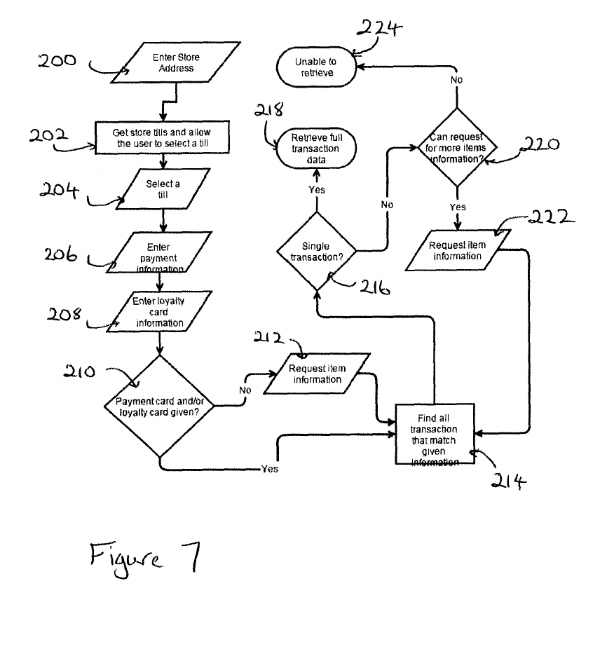

FIG. 7 illustrates a method of retrieving a digital copy of a receipt when the customer is not in possession of the original paper receipt.

The method requires a customer to provide enough information about the transaction to convince the digital receipts system 44 that the customer is a legitimate purchaser.

In one embodiment, the customer logs into an online interface provided by the digital receipts system 44. In order to recover a digital receipt of a transaction at a store the customer is prompted to enter the following information:

In step 200 the digital receipts system 44 prompts the user to select the store/retailer at which they carried out a transaction for which they wish a digital receipt.

In step 202 the digital receipts system 44 provides a representation of the available store tills at the selected retailer and in step 204 the customer selects the till at which they made the purchase.

In step 206 additional information such as the time of the transaction or other payment related information (e.g. card name such as VISA® or MasterCard®, card expiry, last 4 digits of card's PAN, amount paid) are entered by the user.

In step 208 the customer may provide loyalty card information.

In Step 210 the digital receipts system 44 checks the various information provided by the customer. It is noted that the customer may provide information at the above steps 204, 206, 208 or may continue through each step without providing information (e.g. if the customer had not used a loyalty card then they might not provide any information at step 208, if the customer paid in cash then they might skip step 206).

It is also noted that information such as the till used, the time of transaction and the sum paid may be given approximately (within some predefined threshold). For example, at Step 202, the floor plan of the store can be given and the customer may, at step 204, point and click at the approximate till.

If during the check at step 210, the system cannot locate transactions matching the data entered in steps 204, 206 and 208 it may, in step 212 request that the user enter details of the items included in the transaction. The system 44 then moves to step 214 and locates all matching transactions.

If during the check in step 210 that enough information has been provided to identify transactions then, in step 214, the system 44 locates all matching transactions.

In step 216 the system checks if there is only a single matching transaction. If so, then the customer is regarded as successfully matching the transaction related data available to the digital receipts system 44. In step 218 the digital receipts system 44 makes all the transaction related data available to the customer. A delivery address (e.g. an email address) may be collected by the digital receipts system 44 and stored in the customer data module 68. Alternatively the customer may decide to print a physical receipt locally.

In step 216 if the digital receipts system 44 determines that there are multiple transactions that match the information provided by the customer then in step 220 the system checks if further information can be requested. If further information is available then in step 222 the system 44 requests that the user provide more detail on the items in the transaction and then returns to step 214. This process continues until either a single transaction is located or the system determines that it is not possible to identify a single transaction (at which point the method ends at step 224).

The digital receipts system 44 may be used to administer a Coupon/Voucher scheme in accordance with an embodiment of the present invention. Referring to FIGS. 1, 4 and 5, in one embodiment a customer goes into the shop and before or during a transaction presents loyalty card to the cashier. The cashier swipes the card using Magnetic Card Reader 50. An interception module 40 between the POS terminal 3 and the Magnetic Card Reader 50 intercepts this data and stores it as part of transaction meta-data 62. Then, the cashier scans or inputs manually the products the customer bought. At this point the interception module 40 between the POS terminal 3 and the Scanner 7 may be arranged to collect any scanned barcodes as part of the meta-data as well. Finally, the customer pays for the items and a receipt is sent to the Printer 5 for printing. The interception module 40 between the Printer 5 and the POS terminal 3 intercepts this print data and, along with all the data collected as meta-data 62 (e.g. scanned barcodes and data intercepted from the magnetic card reader) is sent to the Transaction Data Repository 66.

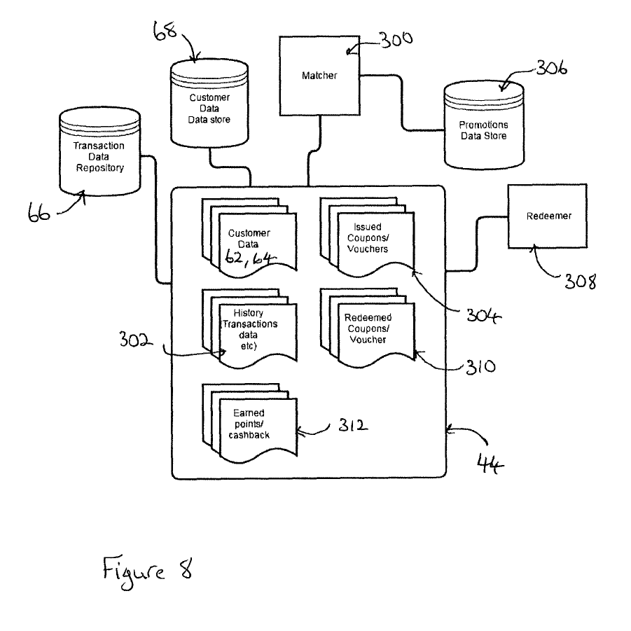

Turning to FIG. 8, the digital receipts system 44 may retrieve transaction related data (such as preference data) from the Transaction Data Repository 66. In the present example, loyalty card data intercepted from the Magnetic Card Reader 50 may be retrieved and used to fetch customer preferences from Customer Data module 68. Another module called a Matcher 300 analyses the current transaction and/or history 302 of the customer's transactions and decides if a coupon 304 should be delivered to the customer. Issuance criteria may be set by the retailer or a coupon/voucher issuing institution 306. If coupon issuance criteria are matched, a coupon/voucher is associated with the customer. These coupons/voucher may then be viewed by the customer using some user interface such as mobile phone application. Every coupon/voucher has a set of redemption criteria (for example spend must be greater than 20 pounds etc). It is noted that issued coupons 304 may be produced for each customer by Matcher 300, which inspects 302 for each customer, and issues coupons into 304. It is noted that, in FIG. 8, the reference numeral 44 encompasses in an instance of data for a single customer.

In one embodiment the user may change preferences and allow the system to redeem coupons/vouchers (associated with the customer) automatically if applicable, or ask for confirmation via some user interface such as mobile application.

Once a voucher/coupon has been issued it may be redeemed during a subsequent transaction. A Redeemer module 308 checks if the latest or any other transaction in the customer's history matches redemption criteria of any voucher/coupons 304 associated with the customer. Whether to check the latest transaction or use the history can be configured per promotion. If there are possible redemptions, then, depending on the customer preferences, the system can redeem the coupon/voucher. A coupon/voucher is then marked as redeemed 310 and some reward of the coupon/voucher is transferred to the customer. The reward can be in form of points 312, or amount of money designated by the coupon/voucher issuer can be transferred to the customer's account.

As the person skilled in the art will appreciate, modifications and variations to the above embodiments may be provided, and further embodiments may be developed, without departing from the spirit and scope of the invention. Reference to standards and proprietary technologies are provided for the purpose of describing effective implementations, and do not limit the scope of the invention.

1. A method of delivering a digital receipt relating to a transaction to a user, the method comprising, at a server:
receiving transaction related data from a point of sale system, the transaction related data having been intercepted in a data communications path between a point of sale terminal and a peripheral device;
analysing the received transaction related data to extract user identification data; querying a user data module using extracted user identification data to determine user preferences relating to delivery of digital receipts;
generating the digital receipt in dependence on the determined user preferences and the received transaction related data;
outputting the digital receipt.

2. A method as claimed in claim 1, wherein the user preferences are stored in the customer data module.

3. A method as claimed in claim 1, wherein the user preferences comprise a message delivery preference and outputting the digital receipt comprises outputting the digital receipt to the user in accordance with the specified message delivery preference.

4. A method as claimed in claim 3, wherein the message delivery preference comprises an electronic communications address.

5. A method as claimed in claim 4, wherein the message delivery preference comprises an email address.

6. A method as claimed in claim 4, wherein the message delivery preference comprises a third party application program interface (API).

7. A method as claimed in claim 3, wherein, in the event that the customer data module does not contain a message delivery preference, generating the digital receipt comprises storing the transaction related data in a data store and awaiting digital receipt delivery information from the user.

8. A method as claimed in claim 3, wherein, in the event that the customer data module does not contain a message delivery preference, generating the digital receipt comprises generating a digital receipt in accordance with a default format, storing the generated receipt in a data store and awaiting digital receipt delivery information from the user.

9. A method as claimed in claim 1, wherein in the event that the customer data module does not contain a message delivery preference for the user, a processor of the server generates a message to request a message delivery preference from the user.

10. A method as claimed in claim 9, wherein generating the message comprises generating a message for insertion into the point of sale system via a data interception module that has been installed on the point of sale system.

11. A method as claimed in claim 10, wherein, upon receipt of a message delivery preference from the point of sale system, the server generates the digital receipt and sends it to the user.

12. A method as claimed in claim 10, wherein, the server sends the received message delivery preference to the customer data module for storing.

13. A method as claimed in claim 1, wherein, in the event that the customer data module does not contain a message delivery preference for the user, a processor of the server is arranged to generate a unique retrieval code to be printed on a physical receipt printed by the point of sale system, the unique retrieval code providing a link to a stored digital receipt for later retrieval by user.

14. A method as claimed in claim 13, wherein the server is arranged to generate a modified print command for a printer peripheral device located at the point of sale system and to send the modified print command to a data interception module installed in a data communications path between the printer peripheral device and a point of sale terminal within the point of sale system.

15. A method as claimed in claim 1, wherein, in the event that the customer data module does not contain a message delivery preference for the user, the method comprises providing a user interface to the user, generating a series of challenge questions to the user, searching available transaction related data in dependence on answers to the challenge questions received via the user interface and, in the event that a single transaction is identified, outputting digital receipt data to the user via the user interface and, in the event that a single transaction cannot be identified, generating further challenge questions for the user.

16. A method as claimed in claim 15, wherein, in the event that a single transaction cannot be identified after generating challenge questions, outputting a notification message to the user confirming that the server cannot identify their transaction.

17. A method as claimed in claim 15, wherein challenge questions comprise a request to confirm one or more of the following: a store location; a store identifier; a point of sale location within a store, time and/or date of a transaction; transaction amount; loyalty card data; transaction card data.

18. A server for delivering a digital receipt relating to a transaction to a user, the server comprising:
an input arranged to receive transaction related data from a point of sale system, the transaction related data having been intercepted in a data communications path between a point of sale terminal and a peripheral device;
a processor arranged to:
analyse the received transaction related data to extract user identification data;
query a user data module using extracted user identification data to determine user preferences relating to delivery of digital receipts;
generate the digital receipt in dependence on the determined user preferences and the received transaction related data;
an output arranged to output the digital receipt.

19. A non-transitory computer readable storage medium comprising computer readable instructions for a computer processor to carry out the method of claim 1.

20. A distributed system for providing a digital receipt relating to a transaction to a user, the system comprising:
(a) a client side computer system arranged to process user transactions, the processing of such user transactions generating transaction related data, the client side computer system comprising a client side processor and a peripheral device;
(b) a user data storage device for storing a plurality of user records, each user record providing one or message delivery preferences for a user;
(c) a computer server in communication via a data communications network with the client side system and the user data storage device, the computer server comprising: (i) an input arranged to receive transaction related data from the client side system, the transaction related data having been intercepted in a data communications path between the client side processor and the peripheral device; (ii) a server side processor arranged to: analyse the received transaction related data to extract user identification data; query the user data storage device using extracted user identification data to determine user message delivery preferences relating to delivery of digital receipts; generate the digital receipt in dependence on the determined user preferences and the received transaction related data; (iii) an output arranged to output the digital receipt.

21. A computer server for providing a digital receipt relating to a transaction to a user, the server being in communication via a data communications network with a client side system for processing user transactions and generating transaction related data and a user data storage device, the server comprising;
(a) an input arranged to receive transaction related data from the client side system, the transaction related data having been intercepted in a data communications path between a client side processor and a peripheral device of the client side system;
(b) a server side processor arranged to: analyse the received transaction related data to extract user identification data; query the user data storage device using extracted user identification data to determine user message delivery preferences relating to delivery of digital receipts; generate the digital receipt in dependence on the determined user preferences and the received transaction related data; and
(c) an output arranged to output the digital receipt.
